(19) United States
(12) Patent Application Publication
(10) Pub. No.: US 2008/0295805 A1
(43) Pub. Date: Dec. 4, 2008

(54) High Pressure Fuel Injector

(75) Inventors: Hermann-Josef Laumen, Heinsberg (DE); Karl J. Schmuecker, Raeren (BE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (GB)

(21) Appl. No.: 12/093,854

(22) PCT Filed: Nov. 15, 2006
(86) PCT No.: PCT/EP2006/010960

§ 371 Date: May 15, 2008

(30) Foreign Application Priority Data
Nov. 15, 2005 (DE) 10 2005 054 361.8

(51) Int. Cl. F02M 47/02; F02M 51/06

(52) U.S. Cl. 123/456; 123/472

(57) ABSTRACT

The present invention relates to an internal combustion engine having a high pressure fuel injector (1) which is arranged in a common rail arrangement, in order to improve the accuracy over in particular a service life of a high pressure fuel injector (1), comprising at least one nozzle needle (5), which can be pressed with a pressing force against a valve seat (12), and at least one solid-state actuator (3) which acts on an actuating piston (23) and is connected directly to a rail pressure supply (7), wherein at least one hydraulic operative connection (22) between the actuating piston (23) and a differential piston (4), which is operatively connected to the nozzle needle (5), is provided in such a way that an activation of the solid-state actuator (3) acts directly on the actuating piston (23), thereby permitting a pressure increase by means of the actuating piston (23) above a rail pressure, which pressure increase, via the differential piston (4), counteracts the pressing force such that the nozzle needle (5) can be raised from the valve seat (12) and at least one injection opening can be opened.

### CROSS-REFERENCE TO RELATED APPLICATIONS

This application claims priority of International Patent Application PCT/EP2006/010960 filed Nov. 15, 2006, which claims priority of German Patent Application 10 2005 054 361.8 filed Nov. 15, 2005, both of which are incorporated herein in their entirety by reference.

### FIELD OF THE INVENTION

The invention concerns an internal combustion engine with a high-pressure fuel injector arranged in a common-rail arrangement.

### BACKGROUND OF THE INVENTION

High-pressure fuel injectors are used increasingly in the field of motor vehicles, in order to optimize a combustion process, for example, with respect to pollution emissions and also consumption. For example, WO 01/63121 discloses a common-rail injector, in which an activated piezoelectric actuator holds a nozzle needle in the rest position, that is, in a closed position. If the piezoelectric actuator is discharged and thus deactivated, pressure is removed from the nozzle needle and allows injection. In such a construction of a high-pressure fuel injector, the actuator is set so that it is energized for 95% of a cycle period, e.g. For an actuator, this can lead to the fact that, because of the nearly continuously applied electric field due to the dipole effect, dissolved or free water from the fuel diffuses through one or more possible protective films for the actuator or its ceramic. There is the possibility that diffused water will collect in the highly porous piezoceramic, concentrate, and with time lead to voltage sparkover. In addition, there is the tendency of ions to migrate from an electrode material into an applied electric field due to a high pulse-pause ratio in the actuator. This migration can similarly lead to voltage sparkover.

In addition, from FIG. 7 of DE 36 21 541 A1, a fuel injector is known in which a change in length of a piezoelectric actuator causes a lifting of the nozzle needle. Here, the actuator is then activated and elongates when an injection process is to be executed. At the end of the activation of the actuator, an acting pressure decreases again, and the nozzle needle drops back into the valve seat.

U.S. Pat. No. 6,520,423 discloses another fuel injector. This fuel injector has a piezoelectric actuator, whose change in length leads to the lifting and dropping of the nozzle needle of the fuel injector. Here, the actuator is also activated, in order to lift the nozzle needle from the valve seat. In the fuel injector, a hydraulic amplification device is to be provided in order to allow improved lifting of the nozzle needle.

The problem of the present invention is to achieve an improvement in accuracy by means of special sensitivity and precise operation of a fuel injector and injection due to this sensitivity and also an extension of the service life of the fuel injector, especially at high pressures in an internal combustion engine.

### SUMMARY OF THE INVENTION

This problem is solved by an internal combustion engine with a high-pressure fuel injector with the features of Claim 1 and also by a method for the high-pressure injection of a fuel with the features of Claim 28. Advantageous implementations and refinements are specified in the corresponding dependent claims.

One proposed internal combustion engine has at least one high-pressure fuel injector, which is arranged in a common-rail arrangement. The high-pressure fuel injector includes at least one nozzle needle that can be pressed with a contact-pressure force against and into a valve seat and at least one solid-body actuator, which acts directly on an activation piston and which is connected directly to a rail-pressure supply, wherein, between the activation piston and a differential piston in active connection with the nozzle needle, there is at least one hydraulic active connection in such a way that an activation of the solid-body actuator acts against the contact-pressure force, so that the nozzle needle can be lifted from the valve seat and at least one injection opening can be opened. Between the nozzle needle and the differential piston there is at least one separation joint. In particular, an assembly made from the differential piston and nozzle needle has at least a two-piece construction. Preferably, the separation joint allows a use of a conventional nozzle needle, for example, made from a servo-controlled system, in which the nozzle and needle represent one structural unit. In this way, already existing nozzle-needle systems can be used. Also, this allows an improved tuning of the nozzle and needle to each other, particularly with respect to the component and/or injection quantity tolerances.

This setup makes it possible for the solid-body actuator to be energized only briefly during an injection cycle or energized with voltage, in order to trigger an injection process. In this way, the risk of a diffusion process of water into the solid-body actuator is at least decreased. Preferably, the solid-body actuator is energized only at a maximum of 50% during a cycle. A full-load quantity is injected, for example, within a crank angle range of approximately 36°, corresponding approximately to one-twentieth of a work cycle for a four-stroke engine. In a two-stroke engine, injection takes place, for example, approximately within one-tenth or, for multiple injections, within one-fifth of a work cycle. In addition, the setup specifically allows a short active chain with a low tolerance especially with respect to fuel quantities to be injected.

The internal combustion engine involves, for example, a reciprocating-piston internal combustion engine, which works according to the diesel or Otto method. In particular, this has several cylinders, which are provided with fuel with the common-rail arrangement. The injector can be used both for 2-stroke and also 4-stroke engines.

The common-rail arrangement here includes, for example, a pressure line, which is supplied by a high-pressure fuel pump. The high-pressure fuel injector is connected, in particular, to the pressure line of the common-rail arrangement and allows an injection of fuel into a cylinder of the internal combustion engine.

According to one refinement, the high-pressure fuel injector has dimensions such that the nozzle needle and the differential piston can each have equal diameters at least across one area. The nozzle needle and the differential piston can be moved, for example, at least partially along the same guide. This allows, for example, an area of the differential piston for receiving pressure for lifting the nozzle needle to project at least partially across a maximum diameter of the nozzle needle. This allows a smaller pressure to be generated, because a large area can be made available. In particular, for the use of a piezoelectric element for generating pressure, the required force to be generated can be reduced in comparison with other systems.

Another implementation provides that the nozzle needle reaches a stationary stop over the valve seat along its guide at one end and reaches its end position at its other end without a stationary stop, but instead a movable stop. A travel path of the nozzle needle therefore can be limited with the differential piston, without a guide of the nozzle needle transitioning into a stop. Preferably, it is thus possible for the nozzle needle to move at least in a first component and the differential piston to move at least in a second component, wherein a guide extends through the first component into the second component, which has an equal guide diameter for the nozzle needle and a part of the differential piston, in order to allow penetration of the nozzle needle or differential piston into the other corresponding component. In addition to simplifying the production and tuning of the tolerances, in this way an adjustment path of the nozzle needle and thus a number and/or size of the nozzle holes or the injection openings can be varied.

Preferably, a transmitter space and a coupling space are separated from each other and each have different pressures. This pressure difference advantageously affects the sensitivity of the system, because only small adjustment forces need be applied, for example, by means of a piezoelectric element. According to one construction, a different pressure is set in the transmitter space than in the coupling space when the nozzle needle is lifted and also lowered. The nozzle needle can undergo a force boost by a spring element and/or a pressure of the fuel to be injected against the valve seat. The spring element and/or the pressure can press against the nozzle needle. Preferably, the spring element is arranged in the differential piston.

Preferably, fuel from the rail-pressure supply is circulated around the solid-body actuator. It is further preferred when an activation of the solid-body actuator acts directly on the activation piston, by means of which an increase in pressure is allowed by means of the activation piston above a pressure level of the rail pressure. This increased pressure is used to act against the contact-pressure force. For this purpose, advantageously, the differential piston is used, to which the increased pressure can be applied.

An active connection between the actuator and the differential piston can be realized in a direct way or also by means of one or more installed parts. There is also the possibility of increasing the pressure by setting an effective area of the activation piston with respect to an effective area of the differential piston to a special ratio. Preferably, the effective area of the activation piston is greater at least by a factor of 2 to 5, preferably by a factor of 3.5 than the effective area of the pressure difference. The effective area of the differential piston is considered to be the resulting area for axial displacement and allowing the buildup of a force opposite the effect of the activation piston.

Preferably, the activation piston and the differential piston are separated from each other by the active hydraulic connection. In particular, the activation piston and differential piston are guided in different piston guides, whose axes are advantageously tilted relative to each other or are offset perpendicularly to each other.

The active connection between the differential piston and the nozzle needle for activating the nozzle needle is realized, in particular, mechanically or hydraulically. Preferably, because the actuator is exposed to the rail pressure, hydraulic separation can be prevented, for example, with the aid of a membrane between the actuator and the rail pressure. Advantageously, the actuator volume can be reduced in this way. In addition, the dosing accuracy of the high-pressure fuel injector is reduced, in particular, into a low-pressure space. However, there is also the possibility that a membrane can be provided and nevertheless fuel at rail pressure circulates around the actuator. For example, a spring bellows can be arranged around the actuator. Here, in particular, a gel-like filler material is provided between the actuator and spring bellows.

According to one implementation, the nozzle needle can be pressed against the valve seat by a spring element and/or by means of pressure of the fuel to be injected. As the spring element, in particular, a compression spring is provided, for example, a helical spring. In addition to the spring, the rail pressure of the fuel is used to press the nozzle needle against the valve seat. In particular, the spring element allows a secure closing of the nozzle needle also for a pressure drop of the rail pressure.

In one refinement, the high-pressure fuel injector has no leakage connector. In particular, the high-pressure fuel injector has no other connector to a fuel line besides a rail-pressure connector. Preferably, fuel fed to a rail-pressure connector is discharged back out of the fuel injector exclusively via the injection opening.

The solid-body actuator can be connected directly to the rail pressure supply in different ways. In a first implementation, the solid-body actuator is in direct contact with the fuel. The solid-body actuator is therefore operated “wet” with fuel and pressurized with rail pressure.

In another implementation, it is provided that the solid-body actuator has a water-diffusion barrier, which preferably separates it from the fuel. Here, the solid-body actuator is exposed directly to the pressure of the rail-pressure supply, but is isolated, for example, hermetically, from the fuel. The water-diffusion barrier prevents, in particular, diffusion of water, for example, into the piezoceramic of the solid-body actuator. As the diffusion barrier, a ceramic protective layer, a synthetic resin, or a metallic spring bellows can be selected.

In one variant, the solid-body actuator is arranged in a gel-filled spring bellows, which separates it from the fuel. Preferably, the gel filling prevents the spring bellows from collapsing under the pressure of the fuel. In addition, the gel filling preferably allows pressure to be transferred from the fuel to the solid-body actuator.

According to one refinement, it is provided that at least the nozzle needle, a coupling space, and also the differential piston are arranged one behind the other in the axial direction of the nozzle needle. The coupling space is, for example, a space that can be filled with fuel and that is enclosed between the nozzle needle and the differential piston in a corresponding guide of the nozzle needle or the differential piston. In particular, through pressure on the differential piston, pressure can be exerted on the nozzle needle. Preferably, the nozzle needle and differential piston are in direct contact. Preferably, the coupling space allows the use of a conventional nozzle needle, where the nozzle and needle represent one structural unit. In this way, already existing nozzle-needle systems can be used.

According to another implementation, the differential piston has a first piston with a first diameter and a second piston with a second diameter, which is greater than the first diameter. In particular, the differential piston allows a transmission of the forces acting on the piston surfaces. The differential piston is here preferably arranged so that the first piston with the smaller diameter is turned toward the coupling space or the nozzle needle. The second piston with the larger diameter is pressurized with the rail pressure, in particular, from fuel on one spring space side of the second piston.

For a connection of the first piston to the second piston, different variants can be provided. In a first variant, the first piston has a material connection to the second piston. In particular, the first piston and the second piston are constructed as an integral differential piston.

According to another variant, the first piston has a positive and/or non-positive connection to the second piston. For example, the first and the second pistons are screwed to each other. Alternatively or additionally, a press fit, adhesive fit, or the like can also be provided.

For one arrangement of the differential piston, according to one refinement, it is provided that the first piston is arranged in a first piston guide and the second piston is arranged in a second piston guide so that they can move together in the axial direction, wherein there is a transmitter space, which includes a transition between the first and the second piston guides, in hydraulic connection with the activation piston. In particular, the transmitter space allows, for example, a difference area formed at a transition of the diameter of the differential piston to be charged with a pressure. The difference area is here to be understood as the area that is visible in an axial projection from the side of the first piston with the smaller diameter than the cylindrical ring. The difference area equals, for example, approximately 20% to 50%, preferably approximately 30% of the area of the activation piston. In particular, through a suitable selection of the pressures acting on each end area and also the difference area, a resulting force can be set on the differential piston. Here, in particular, a spring force acting on the second piston can also be taken into account.

In one variant, the first diameter corresponds approximately to a diameter of the nozzle needle. In particular, the force ratios can be adjusted so that, when the nozzle needle and also the transmitter space and also the second piston area of the differential piston are pressurized, a force-equalizing weight is created, so that through additional pressurization of the second piston with a spring, the nozzle needle is pressed against the valve seat. Specifically, pressurizing the transmitter space can have the effect of lifting the nozzle needle from the valve seat. In a closed state, an area of the nozzle needle underneath the valve seat is advantageously not pressurized with rail pressure.

Especially for supporting the closing process, in one implementation it is provided that in a feed line of the nozzle needle, at least one choke position is provided. For example, this is provided in a connection line between the rail pressure supply. A choke position allows, advantageously, a setting of a dynamic pressure difference between line areas placed on both sides of the choke position. The dynamic pressure difference appears, for example, when the high-pressure fuel injector is activated. In addition, a choke position advantageously reduces pressure oscillations in the fuel, which can appear in a feed line during an activation process.

According to one refinement, it is provided that a tip of the nozzle needle is pressurized at least partially by the fuel. For example, the valve seat and nozzle needle or nozzle-needle guide are constructed in such a way that, viewed in an axial projection of the nozzle needle, only one cylinder ring is pressurized. In particular, through a selection of an area portion of the cylinder ring in comparison with the cross-sectional area of the nozzle needle, the dynamic behavior of the nozzle needle can be influenced. In addition, especially through a suitable selection of the first and the second piston areas and also the difference area and the pressurized area of the nozzle tip, a corresponding hydraulic transmission can be adjusted.

In another implementation, it is provided that guides of the activation piston, differential piston, and/or nozzle needle can have a tight fit in such a way that a leakage volume energizing with a magnetic field causes an expansion of the actuator in the effective direction of the actuator on the activation piston, in particular, due to a transverse contraction of this piston.

A pressure in a fuel supply line connected to the high-pressure fuel injector equals, according to one refinement, more than 1500 bar, advantageously above 1800 bar. In particular, a high fuel pressure allows fine atomization of the fuel to be injected. In addition, preferably, short opening intervals are guaranteed, so that, in particular, a multiple injection operation can be improved. For example, between three to five multiple injections with a corresponding pilot injection, main injection, and secondary injection can be enabled through corresponding control of the valve.

According to another concept, the invention relates to a method for high-pressure injection of the fuel into a combustion chamber of an internal combustion engine, wherein a nozzle needle of a high-pressure fuel injector pressed into a valve seat by a spring element and a fuel pressure with a contact-pressure force is lifted from the valve seat by means of hydraulic pressurization, which acts against the contact-pressure force of the nozzle needle, and at least one injection opening is opened, wherein the hydraulic pressurization is achieved by means of activation at least of a solid-body actuator, which acts on an activation piston and which is in direct connection with a rail pressure supply and is exposed to the pressure of the fuel.

The activation is realized, for example, by means of supplying electrical energy into the solid-body actuator or by means of raising a supplied energy level from a rest energy level to an activation energy level. Preferably, the risk of damaging the solid-body actuator is reduced through free water and/or water dissolved in the fuel, when the solid-body actuator is not controlled continuously. For a piezoelectric solid-body actuator, free water and/or dissolved water is attracted, in particular, when an electric field is applied to the piezoelectric solid-body actuator.

According to one refinement, the solid-body actuator is provided with electrical energy only during an injection process. Advantageously, the risk of damaging the solid-body actuator is largely reduced or limited to the injection phases.

For an activation of the nozzle needle, according to one variant, it is provided that the pressurization is caused in a transmitter space, which is in hydraulic connection with the activation piston and which includes a transition to a first and a second piston guide for receiving a differential piston, by means of which the differential piston, whose diameter in the axial direction has at least one step-shaped tapered section, can be moved against the contact-pressure force, so that a pressure in a coupling space between the differential piston and the needle nozzle drops below the rail pressure, by means of which the nozzle needle is moved by the fuel pressure acting on the tip of the nozzle needle.

According to one refinement, it is provided that for ending a fuel injection, the pressurization is reduced to such an extent that the nozzle needle is again seated due to the force of a spring.

### BRIEF DESCRIPTION OF THE DRAWINGS

The invention will be explained below in more detail with reference to the drawing. However, the invention is not limited to the feature combinations shown there. Instead, features described in the description including the description of the figures and also shown in the figures can be combined with each other to form refinements. Shown are:

FIG. 1, a first arrangement of a high-pressure fuel injector, and

FIG. 2, a second arrangement of a high-pressure fuel injector, and

FIG. 3, a third arrangement of a high-pressure fuel injector.

### DETAILED DESCRIPTION OF THE PREFERRED EMBODIMENTS

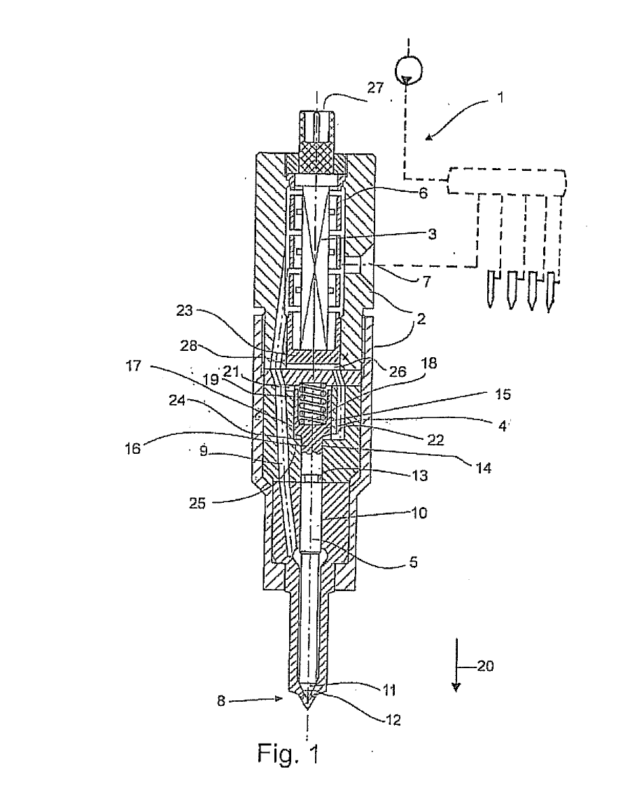

FIG. 1 shows schematically an internal combustion engine with a common-rail system and, in detail, a first arrangement of a high-pressure fuel injector 1 connected to this system. This includes a multiple-part housing 2, in which a solid-body actuator 3, a differential piston 4, and also a nozzle needle 5 are arranged. The solid-body actuator 3 is arranged in an actuator space 6. This space is in direct connection by means of a rail-pressure connection 7 to the fuel (not shown in detail) under rail pressure and the rail pressure supply. For supplying the fuel to at least one injection opening (not shown in detail) in a nozzle tip 8, there is a borehole 9, which connects the actuator space 6 to the nozzle tip 8. The nozzle needle 5 can move in the longitudinal direction in a nozzle needle guide 10. In a closed state of the high-pressure fuel injector 1, the needle tip 11 of the nozzle needle 5 is pressed against a valve seat 12. A contact-pressure force is here transmitted to the nozzle needle 5 by means of the differential piston 4. For this purpose, between the differential piston 4 and the nozzle needle 5 there is a coupling space 13, which is filled with fuel. This thus allows a hydraulic force transmission from the differential piston 4 to the nozzle needle 5. In a not-shown construction, instead of the coupling space 13, a direct mechanical active connection can also be provided. In particular, a direct mechanical active connection can exist at least in one rest position. The differential piston can move in the longitudinal direction in a first piston guide 14 and a second piston guide 15. Here, the differential piston 4 has a first piston 16 and a second piston 17, wherein the second piston has a greater diameter than the first piston. In addition, the second piston advantageously has a cup-shaped construction, so that a spring space 18 is formed. In this spring space there is a compression spring 19, which exerts a pressure force acting in the closing direction 20 on the differential piston 4, which thus acts on the nozzle needle 5 via the coupling space 13. The spring space 18 has a first connection 21 to the borehole 9 and thus to the actuator space 6, so that the fuel is pressurized in the spring space 18 with the rail pressure. For lifting the nozzle needle 5 from the valve seat 12, there is a transmitter space 22, which represents a hydraulic active connection between an activation piston 23 and the differential piston 4. The transmitter space 22 here includes a transition 24 between the first piston guide 14 and the second piston guide 15. In this way, it is allowed that a difference area 25 can be pressurized with a prevailing pressure in the transmitter space 22. For pressurization, the solid-body actuator 3 is provided with an energy feed, so that the solid-body actuator 3 expands. In this way, the activation piston 23 reduces an activation-piston space volume 26. Thus, by setting an appropriate pressure, the pressure on the differential piston 4 can be relieved and it moves against the closing direction 20. The nozzle needle is therefore lifted from the valve seat 12 due to a fuel pressure applied to the needle tip.

For feeding electrical energy, a plug connection 27 is provided. Preferably, the first piston 16, the second piston 17, the needle tip 11, and also the compression spring 19 are dimensioned so that the nozzle needle 5 is pressed against the valve seat 12 for a deactivated solid-body actuator 3. Preferably, an electrical energy feed is required only for an opening process. For this purpose, the solid-body actuator is equipped, for example, as a piezoelectric element. However, a magnetostrictive actuator can also be used by exploiting of transverse expansion.

In a not-shown construction, the solid-body actuator 3 can be hermetically sealed from the fuel by a water-diffusion barrier. Here, the solid-body actuator 3 is enveloped, for example, by a water-diffusion barrier. However, the water-diffusion barrier is constructed, in particular, so that it does not shield a prevailing fuel pressure from the solid-body actuator 3. In particular, the solid-body actuator is exposed to the rail pressure. This equals, for example, at least 1500 bar.

For minimizing leakage in an activation process, it is provided that an activation piston guide 18, a first piston guide 14, and/or a second piston guide 15 have a tight fit in such a way that a leakage volume of fuel, which appears at a valve opening for an activation of the solid-body actuator 3, lies far below a volume output from the activation piston space volume 26 during a valve opening process. Preferably, the leakage volume lies below 10% of the output volume. In a not-shown variant, in particular, supported seals, such as, for example, ring seals, can be used on the corresponding guides.

Below, elements with identical action are provided with identical reference symbols.

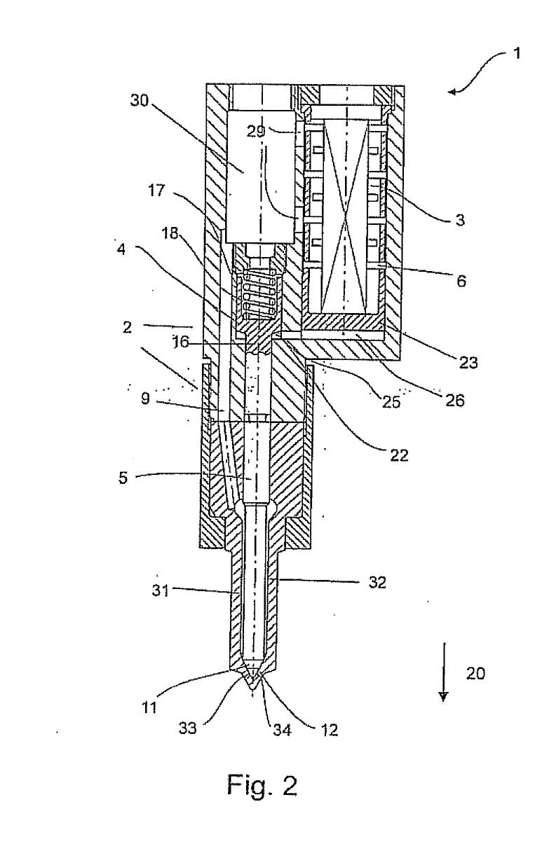

FIG. 2 shows another arrangement of a high-pressure fuel injector 1. The high-pressure fuel injector 1 includes a multiple-part housing 2, in which a solid-body actuator 3, in this case a piezoelectric element, is arranged. In addition, a differential piston 4 and also a nozzle needle 5 are arranged in this housing. The solid-body actuator 3 is installed in an actuator space 6, which connects to a fuel space 30 via connection boreholes 29. The fuel space 30 has a rail pressure connection 7, by means of which the fuel space connects to a not-shown storage line of a common-rail arrangement. Thus, the fuel space 30 is under a pressure with which the fuel is pressurized. The fuel space 30 is connected on one side to a spring space 18 and also, on the other side, by means of a borehole 9 to needle shaft surroundings 31, which surround the nozzle needle 5 on a shaft section 32. The needle shaft surroundings 31 extend so far that a needle tip 11 of the nozzle needle 5 is also at least partially surrounded by fuel. This has the consequence that when the fuel is pressurized, a force acting against a closing direction 20 acts on the needle tip 11, so that a lifting process of the needle tip 11 from a valve seat 12 is enabled. The nozzle needle 5 and differential piston 4 are connected to each other by means of a coupling space 13. This is filled with fuel and allows a force transmission from the differential piston 4 to the nozzle needle 5.

For activating the nozzle needle 5, an activation piston 23 is provided, which is connected to the solid-body actuator 3. The activation piston 23 acts on an activation piston space volume 26, which can be reduced for expansion of the solid-body actuator 3. The activation space volume 26 connects to a transmitter space 22, which includes a transition of the differential piston from a first piston 16 with a first diameter to a second piston 17 with a second diameter that is greater than the first diameter. In this way, a pressure that results in a force acting against the closing direction 20 on the differential piston 4 is exerted on a difference area 25. Accordingly, a pressure in the coupling space 13 decreases, so that due to the fuel pressure applied to the needle tip 11, the nozzle needle 5 is lifted off the valve seat 12. Therefore, a first 33 and a second injection opening 34 are opened, and fuel is injected into a not-shown combustion space.

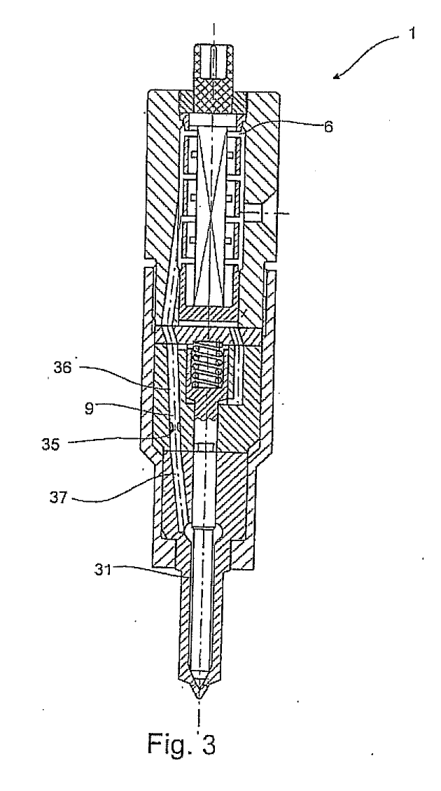

FIG. 3 shows another arrangement of a high-pressure fuel injector 1. This corresponds essentially to the first arrangement shown in FIG. 1. In contrast, the high-pressure fuel injector 1 has a choke position 35 in a borehole 9 arranged between an injector space 6 and needle shaft surroundings 31. The choke position 35 advantageously allows oscillation damping for changes in pressure. In addition, the choke position enables, in particular, the closing process to be supported in that a dynamic pressure difference between areas 36; 37 positioned on both sides of the choke position in the borehole 9 is enabled.

The invention is not restricted to the illustrative examples and embodiments described above. The examples are not intended as limitations on the scope of the invention. Methods, apparatus, compositions and the like described herein are exemplary and not intended as limitations on the scope of the invention. Changes therein and other uses will occur to those skilled in the art. The scope of the invention is defined by the scope of the claims.

We claim:

1. An internal combustion engine with a common rail and at least one high-pressure fuel injector (1), which is arranged in a common-rail arrangement, wherein the high-pressure fuel injector (1) includes at least one nozzle needle (5) that can be pressed against a valve seat (12) with a contact-pressure force and at least one solid-body actuator (3), which acts on an activation piston (23) and which is connected directly to a rail pressure supply, wherein at least one hydraulic active connection is provided between the activation piston (23) and a differential piston (4) in active connection with the nozzle needle (5) in such a way that an activation of the solid-body actuator (3) acts directly on the activation piston, by means of which the pressure can be increased by means of the activation piston above a rail pressure, which acts against the contact-pressure force via the differential piston, so that the nozzle needle (5) can be lifted from the valve seat (12) and at least one injection opening can be opened, wherein at least one separation joint is provided between the nozzle needle and the differential piston (4).

2. The internal combustion engine according to claim 1, characterized in that the nozzle needle (5) and the differential piston (4) of the high-pressure fuel injector (1) each have an equal diameter at least across one area.

3. The internal combustion engine according to claim 1, characterized in that the nozzle needle (5) and the differential piston (4) of the high-pressure fuel injector (1) can move at least partially along the same guide.

4. The internal combustion engine according to claim 1, characterized in that an area of the differential piston (4) of the high-pressure fuel injector (1) to be charged with pressure for lifting the nozzle needle (5) projects at least partially across a maximum diameter of the nozzle needle (5).

5. The internal combustion engine according to claim 1, characterized in that the nozzle needle (5) reaches a stationary stop above the valve seat (12) along its guide at one end and is led at its other end into its end position in the high-pressure fuel injector (1) without a stationary stop, but with a moving stop.

6. The internal combustion engine according to claim 1, characterized in that the nozzle needle (5) can move at least in a first component and the differential piston (4) can move at least in a second component of the high-pressure fuel injector (1), wherein a guide extends through the first into the second component, which has an equal guide diameter for the nozzle needle (5) and a part of the differential piston (4), in order to allow penetration of the nozzle needle (5) of differential piston (4) into the other corresponding component.

7. The internal combustion engine according to claim 1, characterized in that a transmitter space (22) and a coupling space (13) of the high-pressure fuel injector (1) are separated from each other and each have different pressures.

8. The internal combustion engine according to claim 1, characterized in that the nozzle needle (5) can be pressed against the valve seat (12) by a spring element and/or a pressure of the fuel to be injected in the high-pressure fuel injector (1).

9. The internal combustion engine according to claim 8, characterized in that the spring element is arranged in the differential piston (4) of the high-pressure injector (1).

10. The internal combustion engine according to claim 1, characterized in that the high-pressure fuel injector (1) manages without a leakage connection.

11. The internal combustion engine according to claim 1, characterized in that the solid-body actuator (3) in the high-pressure fuel injector (1) is in direct contact with the fuel.

12. The internal combustion engine according to claim 1, characterized in that the solid-body actuator (3) in the high-pressure fuel injector (1) has a water-diffusion barrier, which separates it from the fuel.

13. The internal combustion engine according to claim 1, characterized in that the solid-body actuator (3) is arranged in a gel-filled spring bellows in the high-pressure fuel injector (1), which separates it from the fuel.

14. The internal combustion engine according to claim 1, characterized in that at least the nozzle needle (5), a coupling space (13), and also the differential piston (4) are arranged one behind the other in the high-pressure fuel injector (1) in the axial direction of the nozzle needle (5).

15. The internal combustion engine according to claim 1, characterized in that the differential piston (4) has a first piston (16) with a first diameter and a second piston (17) with a second diameter, which is greater than the first diameter.

16. The internal combustion engine according to claim 15, characterized in that the first piston (16) has a material connection to the second piston (17).

17. The internal combustion engine according to claim 15, characterized in that the first piston (16) has a positive or non-positive connection to the second piston (17).

18. The internal combustion engine according to claim 15, characterized in that the first piston (16) is arranged in a first piston guide (14) and the second piston (17) is arranged in a second piston guide (15) so that they can move together in the axial direction, wherein there is a transmitter space (22) in the high-pressure fuel injector (1), wherein this transmitter space is connected hydraulically to the activation piston (23) and includes a transition between the first and the second piston guide (14, 15).

19. The internal combustion engine according to claim 18, characterized in that the solid-body actuator (3) is arranged in an actuator space (6), which is connected to the rail pressure supply, wherein at least one spring is arranged in a spring space (18), which exerts a pressure force acting in the closing direction of the nozzle needle (5) on the differential piston (4), which is in active connection via a coupling space (13) to the nozzle needle (5), wherein there is at least one connection between the actuator space (6) and the spring space (18), so that a force acting in the closing direction of the nozzle needle (5) can be exerted on the differential piston (4) by means of a pressure in the spring space (18), wherein at least one connection is provided between the actuator space (6) and a tip region (31) of the nozzle needle (5).

20. The internal combustion engine according to claim 15, characterized in that the first diameter corresponds approximately to a diameter of the nozzle needle (5).

21. The internal combustion engine according to claim 1, characterized in that an area of the activation piston (23) in the high-pressure fuel injector (1) is greater by a factor between 2 and 5 than an active area of the differential piston (4).

22. The internal combustion engine according to claim 1, characterized in that at least one choke position (35) is provided in a supply line (9) of the nozzle needle (5) in the high-pressure fuel injector (1).

23. The internal combustion engine according to claim 1, characterized in that a tip of the nozzle needle (5) is pressurized at least partially by the fuel.

24. The internal combustion engine according to claim 1, characterized in that guides of the activation piston (23), differential piston (4), and/or nozzle needle (5) have a tight fit in such a way that a leakage volume of fuel, which appears at a valve opening when the solid-body actuator (3) is activated, is significantly below, in particular, under 10% of a volume output during a valve opening process of the high-pressure fuel injector (1).

25. The internal combustion engine according to claim 1, characterized in that the solid-body actuator (3) of the high-pressure fuel injector (1) includes a piezoelectric element.

26. The internal combustion engine according to claim 1, characterized in that the solid-body actuator (3) of the high-pressure fuel injector (1) includes a magnetostrictive element.

27. The internal combustion engine according to claim 1, characterized in that a pressure in a fuel supply line connected to the high-pressure fuel injector (1) equals more than 1500 bar.

28. A method for high-pressure injection of a fuel into a combustion chamber of an internal combustion engine, wherein a nozzle needle (5) of a high-pressure fuel injector (1) pressed against a valve seat (12) by a spring element and a pressure of the fuel with a contact-pressure force is lifted from the valve seat (12) by means of hydraulic pressurization, which acts against the contact-pressure force of the nozzle needle (5), and at least one injection opening is opened, wherein the hydraulic pressurization is achieved by means of activation of at least one solid-body actuator (3), which acts on an activation piston (23) and which is connected directly to a rail pressure supply and is exposed to the pressure of the fuel, wherein an increase in pressure is generated by means of the activation piston above the rail pressure and a resulting force is used for lifting the nozzle needle (5).

29. The method according to claim 28, characterized in that pressurization is realized in a transmitter space (22) connected hydraulically to the activation piston (23), a differential piston (4) is moved against a contact-pressure force, and a pressure in a coupling space (13) between the differential piston (4) and the nozzle needle (5) drops below the rail pressure, so that the nozzle needle (5) is moved.

30. The method according to claim 29, characterized in that force equilibrium is set for pressurization of the nozzle needle (5), the transmitter space (22), and also a second piston area of the differential piston (4).

31. The method according to claim 28, characterized in that the solid-body actuator (3) is supplied with electrical energy essentially only during an injection process, preferably exclusively only during an injection process.

32. The method according to claim 28, characterized in that the pressurization is realized in a transmitter space (22), which is hydraulically connected to the activation piston (23) and which includes a transition between a first and a second piston guide (14, 15) for holding a differential piston (4), on which a pressure force, which acts against the contact-pressure force, is applied as a function of the resulting cross-sectional areas of the differential piston (4), by means of which the nozzle needle (5) is moved by means of the fuel pressure acting on the tip of the nozzle needle (5).

33. The method according to claim 28, characterized in that multiple injections during a combustion cycle are set through the short-term activation of the solid-body actuator (3).

34. The method according to claim 28, characterized in that for ending fuel injection, the pressurization is reduced far enough to seat the nozzle needle (5) again.

35. The method according to claim 29, characterized in that a different pressure is set in the transmitter space (22) than in the coupling space (13) when the nozzle needle (5) is lifted and also lowered.

36. Use of the method with the features of claim 28 for a 2-stroke method.

37. Use of an Otto principle for an internal combustion engine with the features of claim 1.
